(19) United States
(12) Patent Application Publication
(10) Pub. No.: US 2025/0167209 A1
(43) Pub. Date: May 22, 2025

(54) ELECTRODE MANUFACTURING METHOD AND ELECTRODE MANUFACTURING SYSTEM

(71) Applicant: SK On Co., Ltd., Seoul (KR)

(72) Inventor: Yeong Min JO, Daejeon (KR)

(21) Appl. No.: 18/923,693

(22) Filed: Oct. 23, 2024

(30) Foreign Application Priority Data
Nov. 16, 2023 (KR) 10-2023-0159296

(51) Int. Cl. H01M 4/139; H01M 4/04; H01M 4/62; H01M 4/66

(52) U.S. Cl. CPC H01M 4/139; H01M 4/0416; H01M 4/621; H01M 4/663; H01M 2220/20

(57) ABSTRACT

An electrode manufacturing method according to an embodiment of the present disclosure includes: manufacturing an electrode active material layer using a dry process; laminating the electrode active material layer on an electrode current collector; applying an insulating composition including a photocurable material on the electrode current collector to be in contact with or adjacent to the electrode active material layer; and irradiating light to the insulating composition.

### CROSS-REFERENCE TO RELATED PATENT APPLICATION

The present application claims priority under 35 U.S.C. § 119 (a) to Korean patent application number 10-2023-0159296 filed on Nov. 16, 2023, in the Korean Intellectual Property Office, the entire disclosure of which is incorporated by reference herein.

### BACKGROUND OF THE INVENTION

### 1. Field

Embodiments of the present disclosure relate to an electrode manufacturing method and an electrode manufacturing system.

### 2. Description of the Related Art

Due to the rapid increase in fossil fuel use, the demand for the use of alternative energy and clean energy is increasing, and as a part of this, the most actively researched field is the field of power generation and power storage using electrochemistry. Currently, a representative example of electrochemical devices that use this electrochemical energy is a secondary battery, and its use areas are expanding more and more.

The use of lithium secondary batteries, a representative type of secondary batteries, has been realized not only as an energy source for mobile devices, but recently, as a power source for electric vehicles and hybrid electric vehicles that can replace vehicles that use fossil fuels, such as gasoline vehicles and diesel vehicles, which are one of the main causes of air pollution. Their use areas are also expanding for example, as auxiliary power sources through gridization.

The manufacturing process of these lithium secondary batteries is largely divided into three steps: electrode process, assembly process, and formation process. The electrode process is further divided into active material mixing process, electrode coating process, drying process, rolling process, slitting process, and coiling process.

In the conventional electrode process, during the active material mixing process, solvents for various ingredients such as electrode active materials or conductive materials and/or a large amount of solvents for dispersion are used, and in the electrode coating process, an electrode is formed through a wet process where an electrode mixture composition in the form of a slurry is applied on a current collector, and then the solvent is removed through drying.

However, when an electrode is formed by this wet process, defects such as pinholes or cracks may be generated in an electrode active material layer during the process of evaporating and removing the solvent. In addition, in the drying process, a considerable amount of energy is required to remove a large amount of solvent, and a large and expensive drying device is also required, which has the disadvantage of significantly lowering the overall processability of secondary batteries.

To overcome the disadvantage of this wet process, research has been actively conducted recently on methods for manufacturing dry electrodes for secondary batteries through a dry process that does not use a solvent.

In addition, formation of an insulating layer is required at the edge of an electrode to prevent a short circuit between a cathode and an anode. However, when a dry process is used to form an insulating layer, the edge of the insulating layer is not neat, and when a wet process is used, a separate drying device/process or the like is required, so the advantages of applying a dry process may be significantly diluted.

Accordingly, a new method for forming an insulating layer on a dry electrode is required.

### SUMMARY OF THE INVENTION

Embodiments of the present disclosure provide an electrode manufacturing method and an electrode manufacturing system capable of manufacturing an electrode having a good insulating layer edge shape and excellent insulating properties without having to provide a separate heat source or perform a drying process.

A secondary battery including an electrode manufactured according to one embodiment of the present disclosure can be widely applied in the field of electric vehicles, battery charging stations, energy storage system, and green technology such as photovoltaics and wind power generation using batteries.

An electrode manufacturing method according to an embodiment of the present disclosure includes: manufacturing an electrode active material layer using a dry process; laminating the electrode active material layer on an electrode current collector; applying an insulating composition including a photocurable material on the electrode current collector to be in contact with or adjacent to the electrode active material layer; and irradiating light to the insulating composition.

In one embodiment, the manufacturing the electrode active material layer may further include: forming an active material powder including an electrode active material; and forming an active material film from the active material powder.

In one embodiment, the active material powder may further include one or more selected from the group consisting of a binder and a conductive material.

In one embodiment, the manufacturing the electrode active material layer may further include: trimming an edge of the electrode active material layer.

In one embodiment, the laminating the electrode active material layer on the electrode current collector and the applying the insulating composition may be performed sequentially or simultaneously.

In one embodiment, the photocurable material may include one or more selected from the group consisting of a photocurable oligomer and a photocurable monomer.

In one embodiment, the photocurable oligomer may include an acrylate-based oligomer, and the photocurable monomer may include one or more selected from the group consisting of an acrylate-based monomer and a vinyl ether-based monomer.

In one embodiment, the insulating composition may further include a photoinitiator.

In one embodiment, the insulating composition may be applied to overlap or be adjacent to a part of the electrode active material layer

In one embodiment, the light may include one or more selected from the group consisting of ultraviolet rays, visible light, and electron beam.

An electrode manufacturing system according to an embodiment of the present disclosure includes: an electrode active material layer manufacturing device manufacturing an electrode active material layer through a dry process; a lamination device laminating the electrode active material layer on a part of an electrode current collector; and an insulating layer manufacturing device forming an insulating layer on the electrode current collector to be in contact with or adjacent to the electrode active material layer; wherein the insulating layer manufacturing device includes: a coating portion applying an insulating composition including a photocurable material to the electrode current collector; and a light irradiation portion irradiating light to the insulating composition applied on the electrode current collector.

In one embodiment, the electrode active material layer manufacturing device may include: a powder preparation portion forming active material powder including an electrode active material by mixing raw materials; and a film formation portion forming an active material film from the active material powder.

In one embodiment, the electrode active material layer manufacturing device may further include a trimming portion trimming an edge of the electrode active material layer into a desired shape.

According to the present disclosure, an electrode manufacturing method and an electrode manufacturing system capable of manufacturing an electrode having a good insulating layer edge shape and excellent insulating properties may be provided without having to provide a separate heat source or perform a drying process.

### BRIEF DESCRIPTION OF THE DRAWINGS

FIG. 1 shows a flowchart for explaining an electrode manufacturing method according to an embodiment of the present disclosure.

FIG. 2 shows a diagram for explaining the structure of an electrode manufactured by an electrode manufacturing method according to an embodiment of the present disclosure.

FIG. 3 shows a block diagram for explaining an electrode manufacturing system according to an embodiment of the present disclosure.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the present specification or application. In addition, the technical principle of the present invention is not construed as being limited to the embodiments described in the present specification or application.

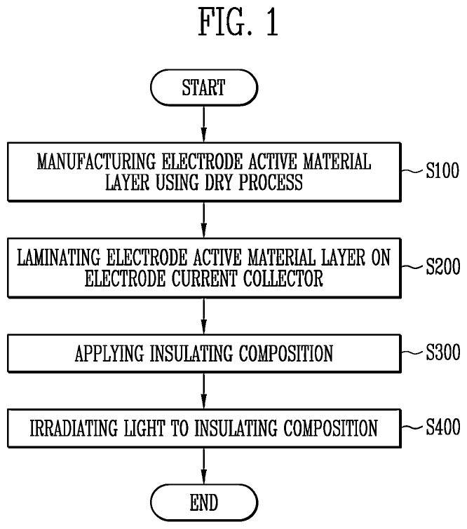

FIG. 1 shows a flowchart for explaining an electrode manufacturing method according to an embodiment of the present disclosure.

An electrode manufacturing method according to the present disclosure may include: manufacturing an electrode active material layer using a dry process; laminating the electrode active material layer on an electrode current collector; applying an insulating composition including a photocurable material on the electrode current collector to be in contact with or adjacent to the electrode active material layer; and irradiating light to the insulating composition.

An electrode manufacturing method according to the present disclosure may include manufacturing an electrode active material layer using a dry process.

Referring to FIG. 1, an electrode active material layer is manufactured using a drying process in operation S100.

In an embodiment, the manufacturing the electrode active material layer may further include: forming an active material powder including an electrode active material; and forming an active material film from the active material powder.

In an embodiment, the operation S100 may include forming an active material powder. In an embodiment, the active material powder may include an electrode active material. In addition, in an embodiment, the active material powder may further include at least one selected from the group consisting of a binder and a conductive material. In one embodiment, the binder may be a fiberized organic binder, but not limited thereto. In one embodiment, an electrode active material, a binder, and a conductive material may be mixed and kneaded under a shear force, and a lump of the resulting mixture formed by the kneading process may be pulverized to prepare active material powder.

In an embodiment, the operation S100 may include forming an active material film from active material powder. In one embodiment, the active material powder may be formed into an active material film through calendering. For example, the active material powder may be introduced between a plurality of rolls, and then calendering may be performed. The calendering process may be performed, for example, by rolls that are positioned face to face, and at this time, the roll temperature may be 50° C. to 200° C., and the roll rotation speed may be 10 rpm to 50 rpm, but is not limited thereto. In addition, in one embodiment, an active material film may be rolled and manufactured to have a thickness of 5 μm to 300 μm, or 7 to 250 μm, but is not limited thereto.

Accordingly, an electrode active material layer formed of an active material film may be obtained through the operation S100.

In an embodiment, the operation S100 may further include trimming an edge of an electrode active material layer. Accordingly, an electrode active material layer may have an edge with a good shape.

Next, an electrode manufacturing method according to the present disclosure may include laminating an electrode active material layer on an electrode current collector. In the electrode manufacturing method according to the present disclosure, an electrode active material layer may be laminated on an electrode current collector in operation S200 of FIG. 1. In an embodiment, the process of laminating an electrode active material layer on an electrode current collector may be a step of rolling and attaching an electrode active material layer on an electrode current collector to a predetermined thickness. The process of laminating an electrode active material layer on an electrode current collector may be performed by rolling rolls, and at this time, the rolling rolls may be maintained at a temperature of 0° C. to 200° C.

Next, an electrode manufacturing method according to the present disclosure may include applying an insulating composition including a photocurable material on an electrode current collector to be in contact with or adjacent to an electrode active material layer. In the electrode manufacturing method according to the present disclosure, an insulating composition may be applied in operation S300 of FIG. 1. In an embodiment, an insulating composition may be applied on an electrode current collector to be in contact with or adjacent to an electrode active material layer. More specifically, an insulating composition may be applied to be in contact with or adjacent to an edge of an electrode active material layer. The insulating composition may be applied to be in contact with, for example, a region where the electrode active material layer is trimmed, but is not limited thereto.

In an embodiment, an insulating composition may include a photocurable material. A photocurable material may be a material that exhibits high intermolecular bond strength by forming cross-links through a chemical reaction when light is irradiated thereon. In one embodiment, the light may be ultraviolet rays, visible light, or electron beam.

In one embodiment, a photocurable material may include one or more selected from the group consisting of a photocurable oligomer and a photocurable monomer.

In one embodiment, the photocurable oligomer may include an acrylate-based oligomer, and the photocurable monomer may include one or more selected from the group consisting of an acrylate-based monomer and a vinyl ether-based monomer.

In one embodiment, a photocurable oligomer may include an acrylate-based oligomer. For example, an acrylate-based oligomer may be one or more selected from the group consisting of urethane acrylate, polyester acrylate, epoxy acrylate, and silicone acrylate, and may have a number-average molecular weight of 50 to 5000.

In one embodiment, a photocurable monomer may include at least one selected from the group consisting of an acrylate monomer and a vinyl ether monomer.

An acrylate-based monomer may be monofunctional or polyfunctional, and may be, for example, one or more selected from the group consisting of hydroxyethyl acrylate (HEA), hydroxyethyl methacrylate (HEMA), 1,6-hexanediol diacrylate (HDDA), tripropylene glycol diacrylate (TPGDA), trimethylolpropane triacrylate (TMPTA), pentaerythritol triacrylate (PETA), and dipentaerythritol hexaacrylate (DPHA).

A vinyl ether-based monomer may be monofunctional or polyfunctional, and may be, for example, one or more selected from the group consisting of butanediol monovinyl ether, 1,4-cyclohexane dimethanol monovinyl ether, and triethylene glycol divinyl ether.

In an embodiment, an insulating composition may further include a photoinitiator. For example, a photoinitiator may be one or more selected from the group consisting of dialkoxy acetophenone, benzyl ketal, hydroxyalkyl phenyl ketone, benzoyloxime ester, amino ketone, an onium salt of triarylsulfonium salt, 2,4,6-trimethylbenzoyl-diphenyl-phosphine oxide, and 2-hydroxy-2-methyl-1-phenyl-propan-1-one.

In one embodiment, an insulating composition may further include a thickener. For example, a thickener may be one or more selected from the group consisting of carboxymethyl cellulose, hydroxyethyl cellulose, polyvinyl alcohol, and polyvinyl acetate. As an insulating composition includes a thickener, the insulating composition may have a viscosity suitable for coating.

In an embodiment, an insulating composition may be applied by one or more methods selected from the group consisting of spray coating methods, roll coating methods, die coating methods, gravure printing methods, and bar coating methods, but is not limited thereto.

In one embodiment, an insulating composition may be applied to a region on an electrode current collector where an electrode active material layer is not laminated, i.e., a non-coated region. In one embodiment, an insulating composition may be applied to overlap or be adjacent to a part of an electrode active material layer. At this time, when the insulating composition and the electrode active material layer are applied to overlap, the width of the overlapping region may be 3 mm or less.

In the case of a conventional insulating composition, when the insulating composition is not applied to overlap at least a part of an electrode active material layer, there is a risk of fracture occurring in a subsequent rolling process, and thus it may be required to apply the insulating composition to overlap at least a part of the electrode active material layer. On the other hand, an insulating composition including a photocurable material as in the present disclosure has relatively little or no risk of fracture occurring in a subsequent rolling process even when it is applied not to overlap at least a part of an electrode active material layer, and thus it may be applied to be simply adjacent to the electrode active material layer without overlapping.

In an embodiment, the laminating the electrode active material layer on the electrode current collector and the applying the insulating composition may be performed sequentially or simultaneously.

In an embodiment, the applying the insulating composition may be performed sequentially after the laminating the electrode active material layer on the electrode current collector.

In another embodiment, the laminating the electrode active material layer on the electrode current collector may be performed sequentially after the applying the insulating composition.

In another embodiment, the laminating the electrode active material layer on the electrode current collector and the applying the insulating composition may be performed simultaneously.

Next, an electrode manufacturing method according to the present disclosure may include irradiating light to an insulating composition. In the electrode manufacturing method according to the present disclosure, light may be irradiated to the insulating composition in operation S400 of FIG. 1. Here, the insulating composition may refer to an insulating composition applied on an electrode active material layer. As described above, the light may be at least one selected from the group consisting of ultraviolet rays, visible light, and electron beam. Through the operation S400, an insulating composition applied on an electrode active material layer may be cured, and thus an insulating layer in contact with or adjacent to the electrode active material layer may be formed. An insulating layer manufactured through operation S400 may have a neat shape compared to those formed through other processes.

In other words, as described with reference to FIG. 1, when an electrode is manufactured using the electrode manufacturing method according to an embodiment of the present disclosure, an electrode having a good insulating layer edge shape and excellent insulating properties can be manufactured without having to provide a separate heat source or perform a drying process.

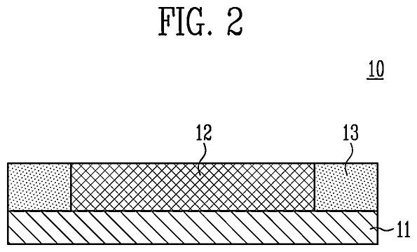

FIG. 2 shows a diagram for explaining the structure of an electrode manufactured by an electrode manufacturing method according to an embodiment of the present disclosure.

Referring to FIG. 2, an electrode 10 manufactured by an electrode manufacturing method according to one embodiment of the present disclosure may include an electrode current collector 11, an electrode active material layer 12, and an insulating layer 13.

An electrode current collector 11 may include stainless steel, nickel, aluminum, copper, titanium, or an alloy thereof. An electrode current collector 11 may also include aluminum, copper, or stainless steel surface-treated with carbon, nickel, titanium, silver, a polymer, an adhesive, or the like. The thickness of an electrode current collector 11 may be, for example, 5 μm to 50 μm, but is not limited thereto.

An electrode active material layer 12 may be laminated on an electrode current collector 11. An electrode active material layer 12 may be a cathode active material layer including a cathode active material or an anode active material layer including an anode active material. When the electrode active material layer 12 is a cathode active material layer, the electrode 10 may be a cathode, and when the electrode active material layer 12 is an anode active material layer, the electrode 10 may be an anode. A cathode active material may include a compound capable of reversibly intercalating and deintercalating lithium ions. In addition, a material capable of adsorbing and extracting lithium ions may be used as an anode active material.

In an embodiment, an electrode active material layer 12 may further include a binder. A cathode active material layer may include, for example, polyvinylidene fluoride (PVDF), a polyvinylidene fluoride-co-hexafluoropropylene copolymer, polyacrylonitrile, polymethylmethacrylate, acrylonitrile butadiene rubber (NBR), polybutadiene rubber (BR), styrene-butadiene rubber (SBR), or the like, as a binder. For example, an anode active material layer may include, for example, an SBR-based binder, carboxymethyl cellulose (CMC), polyacrylic acid, polyvinylpyrrolidone (PVP), a polyethylene (PE)-based binder, or the like, as a binder.

In an embodiment, an electrode active material layer 12 may further include a conductive material to enhance conductivity and/or mobility of lithium ions or electrons. A conductive material may include a carbon-based conductive material such as graphite, carbon black, acetylene black, Ketjen black, graphene, carbon nanotubes, vapor-grown carbon fibers (VGCF), and carbon fibers, and/or a metal-based conductive material including perovskite materials such as tin, tin oxide, titanium oxide, LaSrCoO₃, and LaSrMnO₃, but is not limited thereto.

In an embodiment, an electrode active material layer 12 may be manufactured through a dry process, and an edge shape of the electrode active material layer 12 may be neatly arranged through trimming.

An insulating layer 13 may be formed on an electrode current collector 11 to be in contact with or adjacent to an electrode active material layer 12. An insulating layer 13 may include an insulating material. As described above, an insulating layer 13 may be formed as an insulating composition is photocured. As an insulating layer 13 is formed at an edge of an electrode active material layer 12, the occurrence of a short circuit between electrodes may be prevented.

As an insulating layer 13 is formed through photocuring as described above, it may have a good shape. In other words, a boundary between an insulating layer 13 and an electrode active material layer 12 may be neat, and thus the insulating performance can be improved.

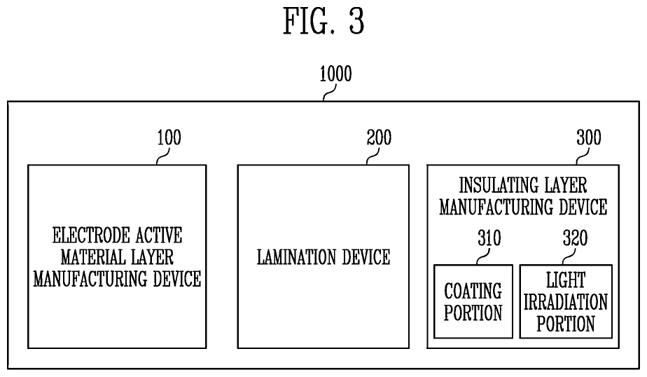

FIG. 3 shows a block diagram for explaining an electrode manufacturing system according to an embodiment of the present disclosure.

An electrode manufacturing system according to the present disclosure may include: an electrode active material layer manufacturing device manufacturing an electrode active material layer through a dry process; a lamination device laminating the electrode active material layer on a part of an electrode current collector; and an insulating layer manufacturing device forming an insulating layer on the electrode current collector to be in contact with or adjacent to the electrode active material layer; wherein the insulating layer manufacturing device may include: a coating portion applying an insulating composition including a photocurable material to the electrode current collector; and a light irradiation portion irradiating light to the insulating composition applied on the electrode current collector.

Referring to FIG. 3, an electrode manufacturing system 1000 may include an electrode active material layer manufacturing device 100. An electrode active material layer manufacturing device 100 may manufacture an electrode active material layer through a dry process. As described above, an electrode active material layer may include an electrode active material.

In one embodiment, an electrode active material layer manufacturing device 100 may include a powder preparation portion and a film formation portion. In other words, in an embodiment, the electrode active material layer manufacturing device may include: a powder preparation portion forming active material powder including an electrode active material by mixing raw materials; and a film formation portion forming an active material film from the active material powder.

The powder preparation portion may form active material powder including an electrode active material by mixing raw materials. More specifically, the powder preparation portion may mix the raw materials and knead them under a shear force, and pulverize the resulting mixture lump formed by the kneading process to prepare active material powder. As described above, the raw materials may include an electrode active material, a binder, a conductive material, and the like.

A film formation portion may form an active material film from active material powder. More specifically, the film formation portion may include a plurality of rolls, and may form an active material film by introducing active material powder between the plurality of rolls and then performing calendaring.

In one embodiment, an electrode active material layer manufacturing device 100 may further include a trimming portion trimming an edge of the electrode active material layer into a desired shape.

In one embodiment, an electrode active material layer manufacturing device 100 may perform operation S100 of FIG. 1.

In addition, an electrode manufacturing system 1000 includes a lamination device 200. A lamination device 200 may laminate an electrode active material layer on a part of an electrode current collector. In other words, a lamination device 200 may receive an electrode active material layer from an electrode active material layer manufacturing device 100 and laminate it on an electrode current collector.

In an embodiment, a lamination device 200 may include rolling rolls, and the lamination device 200 may roll and attach an electrode active material layer to a predetermined thickness on an electrode current collector.

In one embodiment, a lamination device 200 may perform operation S200 of FIG. 1.

In addition, an electrode manufacturing system 1000 includes an insulating layer manufacturing device 300. An insulating layer manufacturing device 300 may form an insulating layer on an electrode current collector to be in contact with or adjacent to an electrode active material layer.

In an embodiment, an insulating layer manufacturing device 300 includes a coating portion 310 and a light irradiation portion 320.

A coating portion 310 may apply an insulating composition including a photocurable material to an electrode current collector. In one embodiment, a coating portion 310 may include a coater for applying an insulating composition. In one embodiment, a coating portion 310 may apply an insulating composition to overlap or be adjacent to a part of an electrode active material layer.

In one embodiment, a coating portion 310 may perform operation S300 of FIG. 1.

In addition, a light irradiation portion 320 may irradiate light to an insulating composition applied on an electrode current collector. In one embodiment, a light irradiation portion 320 may include a light source, and the light source may be a light source that supplies ultraviolet rays, visible light, or electron beam. In one embodiment, a light irradiation portion 320 may perform operation S400 of FIG. 1.

What is claimed is:

1. An electrode manufacturing method, comprising:
manufacturing an electrode active material layer using a dry process;
laminating the electrode active material layer on an electrode current collector;
applying an insulating composition including a photocurable material on the electrode current collector to be in contact with or adjacent to the electrode active material layer; and
irradiating light to the insulating composition.

2. The electrode manufacturing method according to claim 1, wherein the manufacturing the electrode active material layer further includes:
forming an active material powder including an electrode active material; and
forming an active material film from the active material powder.

3. The electrode manufacturing method according to claim 2, wherein the active material powder further includes one or more selected from the group consisting of a binder and a conductive material.

4. The electrode manufacturing method according to claim 2, wherein the manufacturing the electrode active material layer further includes:
trimming an edge of the electrode active material layer.

5. The electrode manufacturing method according to claim 1, wherein the laminating the electrode active material layer on the electrode current collector and the applying the insulating composition are performed sequentially or simultaneously.

6. The electrode manufacturing method according to claim 1, wherein the photocurable material includes one or more selected from the group consisting of a photocurable oligomer and a photocurable monomer.

7. The electrode manufacturing method according to claim 6, wherein the photocurable oligomer includes an acrylate-based oligomer, and the photocurable monomer includes one or more selected from the group consisting of an acrylate-based monomer and a vinyl ether-based monomer.

8. The electrode manufacturing method according to claim 1, wherein the insulating composition further includes a photoinitiator.

9. The electrode manufacturing method according to claim 1, wherein the insulating composition is applied to overlap or be adjacent to a part of the electrode active material layer.

10. The electrode manufacturing method according to claim 1, wherein the light includes one or more selected from the group consisting of ultraviolet rays, visible light, and electron beam.

11. An electrode manufacturing system comprising:
an electrode active material layer manufacturing device manufacturing an electrode active material layer through a dry process;
a lamination device laminating the electrode active material layer on a part of an electrode current collector; and
an insulating layer manufacturing device forming an insulating layer on the electrode current collector to be in contact with or adjacent to the electrode active material layer;
wherein the insulating layer manufacturing device includes:
a coating portion applying an insulating composition including a photocurable material to the electrode current collector; and
a light irradiation portion irradiating light to the insulating composition applied on the electrode current collector.

12. The electrode manufacturing system according to claim 11, wherein the electrode active material layer manufacturing device includes:
a powder preparation portion forming active material powder including an electrode active material by mixing raw materials; and
a film formation portion forming an active material film from the active material powder.

13. The electrode manufacturing system according to claim 12, wherein the electrode active material layer manufacturing device further includes a trimming portion trimming an edge of the electrode active material layer into a desired shape.
